(19) United States
(12) Patent Application Publication
(10) Pub. No.: US 2014/0356734 A1
(43) Pub. Date: Dec. 4, 2014

(54) ELECTROLYTE FOR LITHIUM ION SECONDARY BATTERY AND LITHIUM ION SECONDARY BATTERY COMPRISING THE SAME

(71) Applicant: NingDe Amperex Technology Limited, Ningde City (CN)

(72) Inventors: Jianxun Ren, Dongguan (CN); Chenghua Fu, Dongguan (CN); Fenggang Zhao, Dongguan (CN)

(21) Appl. No.: 13/906,799

(22) Filed: May 31, 2013

(51) Int. Cl. H01M 10/0567; H01M 10/0525

(52) U.S. Cl. CPC H01M 10/0567; H01M 10/0525; H01M 2300/0025; H01M 2220/20
USPC 429/338; 429/188; 429/342; 429/343; 429/336; 429/340; 429/339; 429/337

(57) ABSTRACT

An electrolyte for a lithium ion secondary battery and a lithium ion secondary battery including the same are provide. The electrolyte includes a non-aqueous organic solvent, a lithium salt which is dissolved in the non-aqueous solvent and a additive shown as general formula I. Wherein R₁, R₂ and R₃ are each independently selected from H, alkyl group including from 1 to 12 carbon atoms, cycloalkyl group including from 3 to 8 carbon atoms and aromatic group including 6 to 12 carbon atoms; n represents an integer from 0 to 7. This additive in electrolyte can passivate cathode and anode effectively, restrain their reaction with electrolyte, reduce gases generation and battery's expansion in high temperature surrounding, provide as safety lithium ion secondary batteries.

### TECHNICAL FIELD OF THE INVENTION

Aspects of the present invention relate to an electrolyte for a lithium secondary battery and a lithium secondary battery including the same. More particularly, aspects of the present invention relate to an electrolyte for a lithium secondary battery that generate little gases and show small swollen during high-temperature storage.

### BACKGROUND OF THE INVENTION

Due to the rapid increase in the use of portable computers, mobile phone, video cameras, electric vehicles, etc., there is an increasing demand for larger capacity, smaller size, lighter weight and lower priced rechargeable batteries. Lithium-ion secondary batteries have become the predominant battery technology for handheld electronic applications in the recent decade due to their high energy, high voltage, good cycle life and excellent storage characteristics.

But for electric vehicles, especially heavy-duty vehicles, the requirement of higher energy density can never been satisfied. Now there are two ways to increase battery's energy density, one is the application of high Ni content cathode materials in battery, such LiNiCoAlO and LiNiCoMnO, these materials show higher specific capacity because of their lighter weight, and high capacity is benefit for battery's energy density; the other is increase battery's cut-off voltage, the same cathode materials can release more lithium ion at higher cut-off voltage, and also higher potential platform is benefit for cells energy density.

However, the anode show high reducibility and the cathode show high oxidizability while battery is full charged, and they are liable to react with electrolyte and generate gases and lead battery's expand and swollen. On the other hand, the lasting use and the fluctuation of ambient environment temperature can lead the accumulation of heat, made battery's high temperature and further enhanced the reaction. Unfortunately, both high Ni content and high cut-off voltage can increase cathode's oxidizability, accelerate electrolyte's oxidation, made battery swollen, destroy battery and even the electronic equipment. More seriously, the swollen may lead internal short in battery or leakage of the flammable electrolyte, and cause safety incidents.

So, it is quite necessary to provide an electrolyte that can restrain the reaction with electrode, decrease the gases generation during high temperature environment, and application for safety lithium ion secondary batteries.

### SUMMARY OF THE INVENTION

Aspects of the present invention provide an electrolyte for a lithium ion second battery that generate little gases and show smaller swollen during high-temperature storage.

In order to achieve this technical purpose, the invention adopts the following technical schemes:

a lithium ion battery electrolyte comprises a non-aqueous solvent and a lithium salt which is dissolved in the non-aqueous solvent, wherein the electrolyte also comprises an additive, and the additive is a compound represented by the following general formula (I):

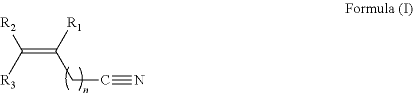

Wherein R₁, R₂ and R₃ are each independently selected from H, alkyl group including from 1 to 12 carbon atoms, cycloalkyl group including from 3 to 8 carbon atoms and aromatic group including 6 to 12 carbon atoms; n represents an integer from 0 to 7.

The molecular structure of the compound represented in the general formula (I) comprises a nitrile group and an carbon-carbon double bond. Both of them, especially the nitrile group, can complex with the transition metal atoms in cathode materials; synchronously, the double bond may be reduced on the anode surface and oxidized on the cathode surface, so as to generate the electrochemical polymerization effect and produce the polymer passive film; the nitrile group can active the unsaturated bond, and enhanced the polymerization. Thus, this additives can passivate the surface of cathode and anode effectively, restrain the reaction of electrolyte on electrode, decrease the gases generate, and improve battery's performance during high temperature surrounding.

For the compound, R₁, R₂ and R₃ are each independently selected from H, alkyl group including from 1 to 12 carbon atoms, cycloalkyl group including from 3 to 8 carbon atoms and aromatic group including 6 to 12 carbon atoms. If the carbon atoms of the groups are too many, the viscosity of the additive may be increased, and the conductivity of the electrolyte may be reduced, thereby the performance of the battery may be deteriorated; at the same time, because of the stereo-hindrance effect of each functional group, the synergistic action of the double bond and the nitrile group is reduced, and the surface reaction activity is reduced, thus the effect for improving the high temperature storage of the battery is reduced.

As one improvement for the lithium ion battery electrolyte provided by the invention, the weight of the additive takes 0.1 wt % to 15 wt % of the total weight of the electrolyte. Preferably, the content of the additive takes 0.1 wt % to 15 wt % of the total weight of the electrolyte. If the proportion is too low, the effect for improving the high temperature storage is poor; and if the proportion is too high, the internal impedance of the battery will be increased because of the passivation effect to the anode and cathode by the electrolyte, thus the battery capacity is reduced. By making the weight of the additive take 0.1 wt % to 15 wt % of the total weight of the electrolyte, higher high temperature performance of the battery can be obtained, and higher capacity also can be obtained.

As one improvement for the lithium ion battery electrolyte provided by the invention, the amount of the additive is from 1 wt % to 10 wt % based on the total electrolyte.

As one improvement for the lithium ion battery electrolyte provided by the invention, the amount of the additive is from 2 wt % to 5 wt % based on the total electrolyte.

As one improvement for the lithium ion battery electrolyte provided by the invention, in the additive, n represents an integer from 1 to 7. For this compound, when the nitrile group connects the unsaturated bond directly, namely, when n is 0, the nitrile group and the unsaturated bond can form a stronger conjugated structure; lead to very easy electrochemical polymerization and large interface impedance of the produced thick film, and then cause the loss of cathode's specific capacity; when the number of the atoms between the nitrile group and the unsaturated bond is not 0, namely, when n is not 0, the compound not only can obviously improve the high temperature storage, but also can reduce the damage to the specific capacity of the battery cathode. Comprehensive consideration of the battery capacity and the high temperature storage performance, the preferable compound is that the nitrile group and the unsaturated bond are not conjugated, namely, the compound represented in the formula I when n is not 0; and considering that, with the increase of n, namely, the increase of the length of molecular carbon chain may increase the viscosity of the electrolyte and reduce the conductivity, it is preferable to take the value of n between 1 and 7.

As one improvement for the lithium ion battery electrolyte provided by the invention, the additive is 3-butenenitrile.

As one improvement for the lithium ion battery electrolyte provided by the invention, the solvent is at least one of Ethylene Carbonate (EC), Propylene Carbonate (PC), Dimethyl Carbonate (DMC), Diethyl Carbonate (DEC), dipropyl carbonate, Ethyl Methyl Carbonate (EMC), propyl methyl carbonate (PMC), Vinylene Carbonate (VC), Fluoro-Ethylene Carbonate (FEC), methyl formate, ethyl acetate, methyl butyrate, methyl acrylate, ethylene sulfite, propylene sulfite, dimethyl sulfite, diethyl sulfite, acid anhydride, N-Methylpyrrolidone (NMP), N-methylformamide, N-methylacetamide, acetonitrile, N,N-Dimethyl Formamide (DMF), sulfolane, dimethyl sulfoxide (DMSO), methane thiomethane, gamma-butyrolactone and tetrahydrofuran.

The other purpose of the invention is to provide a lithium ion secondary battery, comprising an anode current collector and an anode active material which is coated on the anode current collector, a cathode current collector and a cathode active material which is coated on the cathode current collector, an isolating membrane and the electrolyte, wherein the electrolyte is the lithium ion battery electrolyte mentioned in the former sections.

Compared with the conventional art, as the electrolyte used by the lithium ion secondary battery of the invention adds the additive which contains the olefinic bond and nitrile group, the battery has better stability under the full-charging state, because the additive in electrolyte can passivate electrode and restrain the reaction between them, reduce the amount of the gases generation, so the lithium ion secondary battery provided by this invention show small expand and swollen during high temperature surrounding and show improved safety performance.

As one improvement for the lithium ion secondary battery provided by the invention, the anode active material comprises at least one of LiCoO, LiNiO, LiMnO, LiNiMnO, LiNoCoMnO and LiNiCoAlO.

As one improvement for the lithium ion secondary battery provided by the invention, the cathode active material comprises at least one of soft carbon, hard carbon, natural graphite, artificial graphite, silicon, silicon-oxygen compound, silicon-carbon compound or lithium titanate.

The electrolyte provided by the invention can improve the high temperature storage performance of the batteries which are mounted by the anode active materials and the cathode active materials.

### DETAILED DESCRIPTION OF THE INVENTION

### Comparative Example I

### Preparation of Electrolyte

Mix EC, PC and DEC according to the weight ratio of 40:40:20 to obtain the non-aqueous solvent, and take lithium hexafluorophosphate (LiPF₆) as the lithium salt to dissolve into the non-aqueous solvent to obtain the basic electrolyte.

Preparation of Lithium Ion Secondary Battery:

After fully and uniformly stirring and mixing LiNi_{0.5}CO_{0.2}Mn_{0.3}O₂(LNCM) which is the active material, the acetylene black which is the conductive agent and polyvinylidene fluoride (PVDF) which is the binder in the solvent system of NMP according to the weight ratio of 96:2:2, coat the mixer on an Al foil, implement drying and cold-pressing to obtain the cathode electrode.

After fully and uniformly stirring and mixing artificial graphite which is the active material, the acetylene black which is the conductive agent, styrene butadiene rubber (SBR) which is the binder, carbon methyl cellulose sodium (CMC) which is the thickener into the solvent system of de-ionized water according to the weight ratio of 95:2:2:1, coat the mixture on a Cu foil, implement drying and cold-pressing to obtain the anode electrode.

The polyethylene (PE) porous polymer film is taken as the isolating membrane.

The anode plate, isolating membrane and the cathode plate are folded in sequence, the isolating membrane is located between the anode and the cathode to exert the isolating effect, and is wound to obtain a naked battery. Put the naked battery in an external package, inject the prepared basic electrolyte, and then implement packaging.

### Experimental Example I

### Preparation of Electrolyte

Mix ethylene carbonate (EC), propylene carbonate (PC) and diethyl carbonate (DEC) according to the weight ratio of 40:40:20 to obtain the non-aqueous solvent, and take LiPF6 as the lithium salt to dissolve into the non-aqueous solvent to obtain the basic electrolyte. And then add 2-butenenitrile into the basic electrolyte as the additive, and the amount of 2-butenenitrile is 3 wt % based on the total electrolyte.

Preparation of Lithium Ion Battery:

After fully and uniformly stirring and mixing LiNi_{0.5}CO_{0.2}Mn_{0.3}O₂ (LNCM) which is active material, the acetylene black which is the conductive agent and PVDF which is the binder in the solvent system of NMP according to the weight ratio of 96:2:2, coat the mixer on an Al foil, implement drying and cold-pressing to obtain the cathode electrode.

After fully and uniformly stirring and mixing artificial graphite which is active material, the acetylene black which is the conductive agent, SBR which is the binder, CMC which is the thickener into the solvent system of de-ionized water according to the weight ratio of 95:2:2:1, coat the mixture on a Cu foil, implement drying and cold-pressing to obtain the anode electrode.

The PE porous polymer film is taken as the isolating membrane.

The anode plate, isolating membrane and the cathode plate are folded in sequence, the isolating membrane is located between the anode and the cathode to exert the isolating effect, and is wound to obtain a naked battery. Put the naked battery in an external package, inject the prepared basic electrolyte, and then implement packaging.

### Experimental Example II

Different from the Experimental example 1, the non-aqueous solvent of the electrolyte is the mixture of DMC, DEC and EC, of which the weight ratio is 40:40:20; the additive is 4-n-dodecyl-3-butenenitrile; and the amount of 4-n-dodecyl-3-butenenitrile is 0.1 wt % based on the total electrolyte.

The cathode active material is lithium cobaltate (LiCoO₂); and the anode active material is the mixture of natural graphite and hard carbon, of which the weight ratio is 85:15.

The others are the same as the Experimental example I, and are not repeated here.

### Experimental Example III

Different from the Experimental example I, the non-aqueous solvent of the electrolyte is the mixture of EMC, gamma-butyrolactone and VC, of which the weight ratio is 80:10:10; the additive is 3-methyl-3-butenenitrile; and the amount of 3-methyl-3-butenenitrile is 0.5 wt % based on the total electrolyte.

The cathode active material is the mixture of LiCoO2 and lithium nickelate (LiNiO₂), of which the weight ratio is 90:10; and the anode active material is the mixture of natural graphite and soft carbon, of which the weight ratio is 70:30.

The others are the same as the Experimental example I, and are not repeated here.

### Experimental Example IV

Different from the Experimental example I, the non-aqueous solvent of the electrolyte is the mixture of PMC, FEC and N, N-DMF, of which the weight ratio is 90;5:5; the additive is 3-cycloalkyl-4-phenyl-3-butenenitrile; and the amount of 3-cycloalkyl-4-phenyl-3-butenenitrile is 1 wt % based on the total electrolyte.

The cathode active material is the mixture of lithium manganate (LiMnO₂) and LiNiO₂, of which the weight ratio is 20;80; and the anode active material is silicon.

The others are the same as the Experimental example I, and are not repeated here.

### Experimental Example V

Different from the Experimental example I, the non-aqueous solvent of the electrolyte is the mixture of EC, ethyl acetate and NMP, of which the weight ratio is 95:2:3; the additive is 3-phenyl-4-cyclooctyl-4-pentene nitrile; and the amount of 3-phenyl-4-cyclooctyl-4-pentene is 5 wt % based on the total electrolyte.

The cathode active material is the mixture of lithium nickel cobalt aluminium oxide LiNi_{0.5}Co_{0.2}Al_{0.3}O₂ (LNCA) and LiNiO₂, of which the weight ratio is 20:80; and the anode active material is the mixture of silicon oxide and silicon-carbon compound, of which the weight ratio is 60:40.

The others are the same as the Experimental example I, and are not repeated here.

### Experimental Example VI

Different from the experimental example I, the non-aqueous solvent of the electrolyte is the mixture of DMC, DEC and EC, of which the weight ratio is 40:40;20; the additive is 3-butenenitrile, and the amount of 3-butenenitrile is 3 wt % based on the total electrolyte.

The cathode active material is the mixture of LiMnO₂ and LiCoO₂, of which the weight ratio is 45;55; and the anode active material is the mixture of artificial graphite, natural graphite and hard carbon, of which the weight ratio is 50:45:5.

The others are the same as the experimental example I, and are not repeated here.

### Experimental Example VII

Different from the experimental example I, the non-aqueous solvent of the electrolyte is the mixture of EC, ethylene sulfite and acetonitrile, of which the weight ratio is 85:10:5; the additive is 10-p-benzenehexyl-9-decene nitrile; and the amount of 10-p-benzenehexyl-9-decene nitrile is 8 wt % based on the total electrolyte.

The cathode active material is the mixture of lithium nickel manganese oxide (LiNi_{0.5}Mn_{0.5}O₂), LiMnO₂ and LiNiO₂, of which the weight ratio is 10:20:70; and the anode active material is lithium titanate.

The others are the same as the experimental example I, and are not repeated here.

### Experimental Example VIII

Different from the experimental example I, the non-aqueous solvent of the electrolyte is the mixture of PC, DMSO and methyl butyrate, of which the weight ratio is 75:10:15; the additive is 5-heptyl-6-cyclohexyl-5-hexene nitrile; and the amount of 5-heptyl-6-cyclohexyl-5-hexene nitrile is 10 wt % based on the total electrolyte.

The cathode active material is the mixture of LiMnO₂ and LiCoO₂, of which the weight ratio is 45:55; and the anode active material is silicon-carbon compound.

The others are the same as the experimental example I, and are not repeated here.

### Experimental Example IX

Different from the experimental example I, the non-aqueous solvent of the electrolyte solvent is the mixture of DMC, DEC and PC, of which the weight ratio is 50:30:20; the additive is 3-ethyl-4-cyclopropyl-3-butenenitrile; and the amount of 3-ethyl-4-cyclopropyl-3-butenenitrile is 15 wt % based on the total electrolyte.

The cathode active material is the mixture of LiNiO₂ and LiCoO₂, of which the weight ratio is 45:55; the anode active material is the mixture of artificial graphite, natural graphite and soft carbon, of which the weight ratio is 50:45:5.

The others are the same as the experimental example I, and are not repeated here.

### Experimental Example X

Different from the experimental example I, the non-aqueous solvent of the electrolyte solvent is the mixture of DMC, DEC and PC, of which the weight ratio is 70:10;20; the additive is 3-butenenitrile; and the amount of 3-butenenitrile is 2 wt % based on the total electrolyte.

The cathode active material is the mixture of LiNi_{0.5}CO_{0.2}Al_{0.3}O₂ (LNCA) and LiNiO₂, of which the weight ratio is 40:60; and the anode active material is the mixture of artificial graphite, natural graphite and hard carbon, of which the weight ratio is 50:45:5.

The others are the same as the experimental example I, and are not repeated here.

Battery Capacity Test

Respectively take 5 batteries of the Comparative example I and the experimental example I to X, charge the batteries with 0.5C magnification of constant current under normal temperature to reach 4.2V of voltage, further charge the batteries under 4.2V of constant voltage to reach 0.05C of current, and further discharge the batteries with 0.5C magnification of constant current to reach 3.0V of voltage. Take the discharge capacity of the 0.5C constant current in the last step as the battery capacity, and make this capacity divide the weight of the cathode effective active material to obtain the discharge specific capacity of the cathode active material of each battery. The average data of the discharge specific capacity of each group of batteries is shown as table I.

High Temperature Storage Test

Respectively take 5 batteries of the Comparative example I and the experimental example I to X, charge the batteries with 0.5C magnification of constant current under normal temperature to reach 4.2V of voltage, further charge the battery under 4.2V of constant voltage to reach 0.05C of current, make the battery under 4.2V full-charge state. Test the thickness of the fully-charged battery before being storaged and mark the thickness as D0; and put the fully-charged battery into a baking oven at 85° C., take out the battery after baking 4 hours, immediately test the thickness of the battery after being storaged and mark the thickness as D1. Calculate the thickness expansion rate of the battery before and after being storaged according to the following formula:

£=(D₁−D₀)/D₀×100%

the obtained average thickness expansion rate of each group of batteries is shown as table I.

Via the observation of the data in the comparative example I, the experimental example I and the experimental example VI in the table I, the high temperature storage performance of the batteries can be effectively improved by adding 3 wt % of 2-butenenitrile or 3 wt % of 3-butenenitrile into the basic electrolyte. Compared with the 56.1% thickness expansion rate of the basic electrolyte battery, adding 3 wt % of 2-butenenitrile or 3 wt % of 3-butenenitrile can lead only 12.9% and 13.8% thickness expansion rate, show obvious improvement. But compared with the 149.4 mAh/g cathode specific capacity of the basic electrolyte, adding 3 wt % of 2-butenenitrile or 3 wt % of 3-butenenitrile are respectively 140.3 mAh/g and 147.1 mAh/g, which are respectively reduced by 6.1% and 1.5%. Thereby, the 2-butenenitrile and 3-butenenitrile have obvious improvement effect for the high temperature storage performance; but as the nitrile group and the double bond of 2-butenenitrile are connected directly, the conjugated structure thereof may cause larger loss of cathode specific capacity; the nitrile group and the olefinic bond of 3-butenenitrile are separated by one carbon atom, so the loss for cathode specific capacity can be much smaller. Thus, this compound preferably selects the structure of which the number of carbon atoms between the nitrile group and the olefinic bond is not 0.

Via the observation of the data in the comparative example I and the experimental example II to X in the table I, the specific capacity of the battery cathode is reduced after adding the additive provided by the invention into the basic electrolyte. When the amount of the additive less than 1%, the loss of the cathode specific capacity is less than 0.5%; when the addition amount of the additive is 5%, the loss amount of the cathode specific capacity is 1.3%; when the addition amount of the additive reaches 15%, the loss of the anode specific capacity reaches 11.9%. However, with the increase of the addition amount of the additive, the thickness expansion rate of the batteries after being storaged under 85° C. also can be reduced. The thickness expansion rate of the battery in the comparative example after being storage under 85° C. reaches 56%; but after adding 1% of the additive, the thickness expansion rate is reduced to be 17.1%; when the addition amount of the additive is 15%, the thickness expansion rate is only 6.9%. By integrally considering the capacity and the thickness expansion rate, 0.1% to 15% of addition mount of the additive is preferable.

TABLE I
The cathode discharge specific capacity and 85° C. storage
thickness expansion rate of the lithium ion batteries in
comparative example I and the experimental example I to X

| | Anode discharge | 85° C.storage |
|---|---|---|
| | specific capacity | thickness |
| Group | (mAh/g) | expansion rate |
| Comparative example I | 149.4 | 56.1% |
| Experimental example I | 140.3 | 12.9% |
| Experimental examplet II | 149.1 | 51.2% |
| Experimental example III | 149.2 | 21.6% |
| Experimental example IV | 148.7 | 17.1% |
| Experimental example V | 147.4 | 14.8% |
| Experimental example VI | 147.1 | 13.8% |
| Experimental example VII | 145.5 | 10.2% |
| Experimental example VIII | 141.8 | 7.4% |
| Experimental example IX | 131.6 | 6.9% |
| Experimental example X | 147.3 | 14.2% |

Although a few example of the present invention have been shown and described, it would be appreciated by those skilled in the art that changes may be made in this examples without departing from the principles and spirit of the invention, the scope of which is defined in the claims and their equivalents.

What is claimed is:

1. A lithium ion secondary battery electrolyte, comprising a non-aqueous organic solvent and a lithium salt which is dissolved in the non-aqueous solvent, wherein the electrolyte also comprises an additive; and
the additive is a compound represented by the following general formula (I): 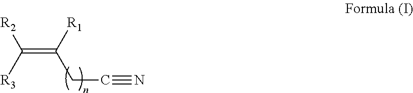
Wherein R₁, R₂ and R₃ are each independently selected from H, alkyl group including from 1 to 12 carbon atoms, cycloalkyl group including from 3 to 8 carbon atoms and aromatic group including 6 to 12 carbon atoms; n represents an integer from 0 to 7.

2. The lithium ion battery electrolyte according to claim 1, wherein the amount of the additives is from 0.1 wt % to 15 wt % based on the total electrolyte.

3. The lithium ion battery electrolyte according to claim 2, wherein the amount of the additives is from 1 wt % to 10 wt % based on the total electrolyte.

4. The lithium ion battery electrolyte according to claim 3, wherein the amount of the additives is from 2 wt % to 5 wt % based on the total electrolyte.

5. The lithium ion battery electrolyte according to claim 1, wherein in the additive molecular structure, n is an integer from 1 to 7.

6. The lithium ion battery electrolyte according to claim 3, wherein the additive is 3-butenenitrile.

7. The lithium ion battery electrolyte according to claim 1, wherein the solvent is at least one of Ethylene Carbonate (EC), Propylene Carbonate (PC), Dimethyl Carbonate (DMC), Diethyl Carbonate (DEC), dipropyl carbonate, Ethyl Methyl Carbonate (EMC), methyl propyl carbonate, Vinylene Carbonate (VC), Fluoro-Ethylene Carbonate (FEC), methyl formate, ethyl acetate, methyl butyrate, methyl acrylate, ethylene sulfite, propylene sulfite, dimethyl sulfite, diethyl sulfite, acid anhydride, N-Methylpyrrolidone (NMP), N-methylformamide, N-methylacetamide, acetonitrile, N,N-Dimethyl Formamide (DMF), sulfolane, dimethyl sulfoxide (DMSO), methane thiomethane, gamma-butyrolactone and tetrahydrofuran.

8. A lithium ion battery, comprising an anode current collector and an anode active material which is coated on the anode current collector, a cathode current collector and a cathode active material which is coated on the cathode current collector, an isolating membrane and the electrolyte, wherein the electrolyte is the lithium ion battery electrolyte according to claim 1.

9. The lithium ion battery according to claim 8, wherein the cathode active material comprises at least one of LiCoO, LiNiO, LiMnO, LiNiMnO, LiNiCoMnO and LiNiCoAlO.

10. The lithium ion battery according to claim 8, wherein the anode active material comprises at least one of soft carbon, hard carbon, natural graphite, artificial graphite, silicon, silicon-oxygen compound, silicon-carbon compound or lithium titanate.
